(19) United States
(12) Patent Application Publication
(10) Pub. No.: US 2021/0024760 A1
(43) Pub. Date: Jan. 28, 2021

(54) LASER MARKING INK COMPOSITION AND PACKAGING MATERIAL

(71) Applicant: DAINICHISEIKA COLOR & CHEMICALS MFG. CO., LTD., Tokyo (JP)

(72) Inventors: Kasumi IGARASHI, Tokyo (JP); Hayakazu MASAOKA, Tokyo (JP)

(21) Appl. No.: 16/966,091

(22) PCT Filed: Jan. 28, 2019
(86) PCT No.: PCT/JP2019/002655

§ 371 Date: Jul. 30, 2020

(30) Foreign Application Priority Data
Mar. 28, 2018 (JP) 2018-062224

(51) Int. Cl. C09D 11/037; B41M 5/32; B41M 5/46; B65D 25/20; C09D 11/50; C09D 11/107

(52) U.S. Cl. CPC C09D 11/037; B41M 5/32; C09D 11/107; B65D 25/20; C09D 11/50; B41M 5/46

(57) ABSTRACT

The present invention provides a laser marking ink composition with which a laser marking layer that enables recording with satisfactory visibility can be formed. This laser marking ink composition is a laser marking ink composition containing a binder resin (A), and titanium oxide (B) that causes color development in the laser marking layer by irradiation with laser light, wherein the titanium oxide (B) comprises at least one surface-treated titanium oxide (B_{I}) selected from the group consisting of alumina-treated titanium oxide (b₁), alumina-silica composite-treated titanium oxide (b₂), and ATO-treated titanium oxide (b₃), and at least one of condition 1 such that a ratio of a content of the surface-treated titanium oxide (B_{I}) to a content of the binder resin (A), (B_{I}/A), is 2.5 to 6.5 on a solid content mass ratio basis and condition 2 such that a ratio of a content of the titanium oxide (b₃) to a content of the binder resin (A), (b₃/A), is 1.0 to 6.5 on a solid content mass ratio basis is satisfied.

### TECHNICAL FIELD

The present invention relates to a laser marking ink composition and a packaging material.

### BACKGROUND ART

Various kinds of information, such as a trade name, a lot number, a date of production, a best before date, an expiration date for use, and a manufacturer's name, are recorded on packaging materials and the like, which include: various types of packaging containers for storing food, beverages, pharmaceuticals, quasi-drugs, cosmetics, and the like; and various types of packing materials and the like, such as films and paper. As a method for performing such recording, a laser marking system in which recording (so-called laser printing) is performed by irradiating an object with laser light has become wide-spread.

The laser marking system is of a so-called non-contact type and therefore has advantages such as enabling high-precision recording, enabling a high-speed recording, and enabling recording on objects having various surface shapes. Further, the laser marking system also has an advantage of enabling recording which is difficult to erase as compared to recording by hot stamp systems and by inkjet recording systems.

In the laser marking system, marking is performed by forming a laser marking layer with an ink on an object of performing laser marking and irradiating the laser marking layer with laser light. In such a laser marking system, various studies to enable laser printing with high visibility have been conducted up until today.

For example, in Patent Literature 1, there is proposed a packaging material provided with: a colored ink layer on which laser printing is to be performed; and a silver-colored ink layer (reflection layer) that reflects laser light into the colored ink layer on a base material for the purpose of enabling clear laser printing. In addition, in Patent Literature 2 for example, there is proposed a laser marking ink composition using ammonium octamolybdate for the purpose of enhancing visibility, the laser marking ink composition containing: this ammonium octamolybdate; predetermined polyurethane resin and vinyl chloride/vinyl acetate copolymer resin; and an organic solvent.

### CITATION LIST

### Patent Literature

Patent Literature 1: Japanese Patent Laid-Open No. 2011-148197

Patent Literature 2: Japanese Patent Laid-Open No. 2016-222822

### SUMMARY OF INVENTION

### Technical Problem

It is beneficial to enable laser printing with high visibility in a laser marking layer without relying on means that increases a step such as providing another layer or the like, like the reflection layer disclosed in Patent Literature 1 described previously, which is different from the laser marking layer. To achieve this, it is considered that a special color-developing pigment, such as ammonium octamolybdate disclosed in Patent Literature 2 described previously, needs to be used in an ink composition for forming a laser marking layer.

However, in the laser marking system, it is desired to form a laser marking layer that enables recording with satisfactory visibility using an inexpensive ink composition without using a special color-developing pigment.

Accordingly, the present invention intends to provide a laser marking ink composition with which a laser marking layer that enables recording with satisfactory visibility can be formed without using a special color-developing pigment, such as ammonium octamolybdate.

### Solution to Problem

The present invention provides a laser marking ink composition to be used for forming a laser marking layer, the ink composition containing: a binder resin (A); and titanium oxide (B) that causes color development in the laser marking layer by irradiation with laser light, wherein the titanium oxide (B) contains at least one surface-treated titanium oxide (B_{I}) selected from the group consisting of titanium oxide (b₁) surface-treated with alumina, titanium oxide (b₂) surface-treated with alumina and silica, and titanium oxide (b₃) coating-treated with antimony-doped tin oxide, and at least one of the following conditions 1 and 2 is satisfied.

Condition 1: a ratio of a content of the surface-treated titanium oxide (B_{I}) to a content of the binder resin (A), (B_{I}/A), is 2.5 to 6.5 on a solid content mass ratio basis.

Condition 2: the titanium oxide (B) contains at least the titanium oxide (b₃), and a ratio of a content of the titanium oxide (b₃) to a content of the binder resin (A), (b₃/A), is 1.0 to 6.5 on a solid content mass ratio basis.

In addition, the present invention provides a laser marking ink composition to be used for forming a laser marking layer, the ink composition containing: a binder resin (A); and titanium oxide (B) that causes color development in the laser marking layer by irradiation with laser light, wherein the titanium oxide (B) contains: titanium oxide (b₃) coating-treated with antimony-doped tin oxide; and titanium oxide (b₄) other than the titanium oxide (b₃), the titanium oxide (b₄) having an oil absorption of 19 g/100 g or more, and a ratio of a total content of the titanium oxide (b₃) and the titanium oxide (b₄) to a content of the binder resin (A), [(b₃+b₄)/A], is 1.0 to 6.5 on a solid content mass ratio basis.

### Advantageous Effects of Invention

According to the present invention, a laser marking ink composition with which a laser marking layer that enables recording with satisfactory visibility can be formed without using a special color-developing pigment, such as ammonium octamolybdate, can be provided.

### DESCRIPTION OF EMBODIMENTS

Hereinafter, embodiments of the present invention will be described, but the present invention is not limited to the following embodiments.

<Laser Marking Ink Composition>

A laser marking ink composition according to one embodiment of the present invention (hereinafter, sometimes simply written as “ink composition”) is used for forming a laser marking layer. This ink composition contains: a binder resin (A); and titanium oxide (B) that causes color development in the laser marking layer by irradiation with laser light.

The present inventors have conducted diligent studies on an ink composition with which a laser marking layer that enables recording with satisfactory visibility can be formed without using a special color-developing pigment, such as ammonium octamolybdate. As a result, the present inventors have found that when an ink composition in which titanium oxide on which a particular surface treatment has been performed is contained in a particular amount based on the amount of a binder resin is used, the color developability by laser is thereby specifically enhanced, so that a laser marking layer that enables recording with satisfactory visibility is obtained.

That is, the ink composition of the first aspect contains as titanium oxide (B) at least one surface-treated titanium oxide (B_{I}) selected from the group consisting of titanium oxide (b₁) surface-treated with alumina, titanium oxide (b₂) surface-treated with alumina and silica, and titanium oxide (b₃) coating-treated with antimony-doped tin oxide. This ink composition satisfies at least one of the following conditions 1 and 2.

Condition 1: a ratio of a content of the surface-treated titanium oxide (B_{I}) to a content of the binder resin (A), (B_{I}/A), is 2.5 to 6.5 on a solid content mass ratio basis.

Condition 2: the titanium oxide (B) contains at least the titanium oxide (b₃), and a ratio of a content of the titanium oxide (b₃) to a content of the binder resin (A), (b₃/A), is 1.0 to 6.5 on a solid content mass ratio basis.

In addition, as a result of diligent studies, the present inventors have found that when an ink composition in which a combination of titanium oxide on which a particular surface treatment is performed and titanium oxide having a particular oil absorption is contained in a particular amount based on the amount of a binder resin is used, the color developability by laser is thereby specifically enhanced, so that a laser marking layer that enables recording with satisfactory visibility is obtained.

That is, the ink composition of the second aspect contains as titanium oxide (B): titanium oxide (b₃) coating-treated with antimony-doped tin oxide; and titanium oxide (b₄) other than the titanium oxide (b₃), the titanium oxide (b₄) having an oil absorption of 19 g/100 g or more. In this ink composition, a ratio of a total content of the titanium oxide (b₃) and the titanium oxide (b₄) to a content of the binder resin (A), [(b₃+b₄)/A], is 1.0 to 6.5 on a solid content mass ratio basis.

When printing or the like is performed with the ink composition according to one embodiment of the present invention on a base material to be an object of providing a laser marking layer, a laser marking layer containing a binder resin and particular titanium oxide in a particular ratio can thereby be formed on the base material. Irradiating this laser marking layer with laser light enables recording (laser marking) with satisfactory visibility. In addition, a laser marking layer that enables recording with satisfactory visibility can be formed with the ink composition without containing a special color-developing pigment, such as ammonium octamolybdate, and therefore the ink composition can be prepared inexpensively. Next, each component in the ink composition will be described.

The binder resin (A) is not particularly limited as long as it is a resin that can be used as an ink composition. Examples of a suitable binder resin (A) include an acrylic resin, a urethane-modified acrylic resin, a styrene-acrylic copolymer resin, an ethylene-acrylic copolymer resin, a polyurethane resin, a polyester resin, a polystyrene resin, a rosin-modified maleic acid resin, a vinyl chloride-vinyl acetate copolymer resin, an ethylene-vinyl acetate copolymer resin, a polyvinyl acetal resin, and a polyamide resin, and cellulose-based resins such as hydroxyethyl cellulose, hydroxypropyl cellulose, and nitrocellulose. One of these can be used singly, or two or more of these can be used in combination. In the present specification, the acrylic resin refers to a resin containing 50 mol % or more (preferably, 60 mol % or more) of a constituent unit derived from a monomer having an acryloyl group and/or a methacryloyl group based on the amount of all the constituent units derived from monomers constituting the acrylic resin.

The binder resin to be used can appropriately be selected according to: the material of the base material to be an object of providing the ink composition (laser marking layer); the intended use where the base material is used; and the like. For example, when an amorphous PET (A-PET) film, which is used for packaging containers for food (such as a tray for food), is used as a base material, one, or two or more of a polyurethane resin, an acrylic resin, and a cellulose-based resin are preferably used as the binder resin (A) in an ink composition to be provided on the base material. Among others, one or both of an acrylic resin and a cellulose-based resin are more preferably used, and an acrylic resin and a cellulose-based resin are still more preferably used together.

In addition, for example, when a plastic film, such as a PET film, which is used for a laminate packaging material, is used as a base material, a polyurethane resin is preferably used as a binder resin (A) in an ink composition to be provided on the base material from the viewpoint of applicability to lamination. When the binder resin (A) contains a polyurethane resin, a laser marking layer which is formed with the ink composition can thereby be used suitably for a laminate packaging material. Further, for example, when a PET shrink film, which is used for a shrink packaging material which is utilized for a PET bottle or the like, is used as a base material, any one or both of a polyurethane resin and a cellulose-based resin are preferably used, and a polyurethane resin and a cellulose-based resin are more preferably used together as a binder resin (A) in an ink composition to be provided on the base material.

The above-described polyurethane resin is obtained by, for example, synthesizing a urethan prepolymer through a reaction of a diisocyanate compound and a polyol compound, and reacting a chain extender or a reaction terminator with the urethane prepolymer as necessary. As the diisocyanate compound, the polyol compound, the chain extender, and the reaction terminator, each of those which have conventionally been used and known can be used.

Examples of the diisocyanate compound include an aromatic diisocyanate, an aliphatic diisocyanate, and an alicyclic diisocyanate. Specific examples of the aromatic diisocyanate include 2,4-tolylene diisocyanate, 2,6-tolylene diisocyanate, xylene-1,4-diisocyanate, xylene-1,3-diisocyanate, 4,4-diphenylmethane diisocyanate, 2,4-diphenylmethane diisocyanate, 4,4-diphenyl ether diisocyanate, 2-nitrodiphenyl-4,4-diisocyanate, 2,2-diphenylpropane-4,4-diisocyanate, 3,3-dimethyldiphenylmethane-4,4-diisocyanate, 4,4-diphenylpropane diisocyanate, m-phenylene diisocyanate, p-phenylene diisocyanate, naphthylene-1,4-diisocyanate, naphthylene-1,5-diisocyanate, and 3,3-dimethoxydiphenyl-4,4-diisocyanate. Specific examples of the aliphatic diisocyanate include tetramethylene diisocyanate, hexamethylene diisocyanate, and lysine diisocyanate. Specific examples of the alicyclic diisocyanate include isophorone diisocyanate, norbornane diisocyanate, hydrogenated tolylene diisocyanate, hydrogenated xylene diisocyanate, and hydrogenated diphenylmethane diisocyanate. One of these diisocyanate compounds can be used singly, or two or more of these diisocyanate compounds can be used in combination.

Examples of the polyol compound include a polyester polyol, a polycarbonate polyol, and a polyether polyol. One of the polyol compounds can be used singly, or two or more of the polyol compounds can be used in combination. Examples of the polyester polyol include a polyester polyol or a polyester amide polyol obtained by a dehydrating polycondensation between a polyvalent carboxylic acid and a polyhydric alcohol or a secondary to tertiary amine. Specific examples of the polyvalent carboxylic acid include: succinic acid, adipic acid, sebacic acid, azelaic acid, terephthalic acid, isophthalic acid, orthophthalic acid, hexahydroterephthalic acid, hexahydroisophthalic acid, hexahydroorthophthalic acid, and naphthalene dicarboxylic acid; a polycarboxylic acid, such as trimellitic acid; esters of these acids; and anhydrides of these acids, and at least one of these can be used. Specific examples of the polyhydric alcohol include: low-molecular-weight alcohol compounds, such as ethylene glycol, 1,2-propanediol, 1,3-propanediol, 1,2-butanediol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, diethylene glycol, dipropylene glycol, 1,4-cyclohexanedimethanol, an ethylene oxide or propylene oxide adduct of bisphenol A, trimethylolpropane, glycerin, and pentaerythritol; and low-molecular-weight aminoalcohol compounds, such as monoethanolamine and diethanolamine, and at least one of these can be used. Specific examples of the secondary to tertiary amine include low-molecular-weight amine compounds, such as hexamethylenediamine, xylylenediamine, and isophoronediamine, and at least one of these can be used. In addition, as the polyester polyol, for example, a lactone-based polyester polyol which is obtained by subjecting a cyclic ester (lactone) monomer, such as ε-caprolactone or γ-valerolactone, to ring-opening polymerization using a low-molecular-weight alcohol compound, a low-molecular-weight aminoalcohol compound, and the like each as an initiator can also be used.

Examples of the polycarbonate polyol include: a polycarbonate polyol which is obtained by a dehydrochlorination reaction between a low-molecular-weight alcohol compound, which is used for synthesizing a polyester polyol, and phosgene; and a polycarbonate polyol which is obtained by a transesterification reaction between the low-molecular-weight alcohol compound and diethylene carbonate, dimethyl carbonate, diethyl carbonate, diphenyl carbonate, or the like.

Examples of the polyether polyol include: a polyoxyethylene polyol, a polyoxypropylene polyol, a polytetramethylene ether polyol, a polyoxyethylene polyoxypropylene polyol, and the like obtained by subjecting an alkylene oxide, such as ethylene oxide, propylene oxide, and butylene oxide, tetrahydrofuran, or the like to ring-opening polymerization using a low-molecular-weight alcohol compound, a low-molecular-weight amine compound, or a low-molecular weight amino alcohol compound, which is used for synthesizing a polyester polyol, a phenol, or the like as an initiator. Examples of the polyether polyol further include a polyester polyol obtained by using the previously described polyester polyol or polycarbonate polyol as an initiator.

Examples of the chain extender include: aliphatic diamines, such as ethylenediamine, propylenediamine, tetramethylenediamine, and hexamethylenediamine; alicyclic diamines, such as isophoronediamine and 4,4′-dicyclohexylmethanediamine; aromatic diamines, such as toluylenediamine; araliphatic diamines, such as xylene diamine; diamines having a hydroxy group, such as N-(2-hydroxyethyl)ethylenediamine, N-(2-hydroxyethyl)propylenediamine, and N,N′-di(2-hydroxyethyl)ethylenediamine; and diol compounds, such as ethylene glycol, propylene glycol, 1,4-butanediol, neopentyl glycol, diethylene glycol, and triethylene glycol. Further, a polyamine, such as diethylenetriamine or triethylenetetramine can be used together in a range where the polyurethane resin does not gel.

Examples of the reaction terminator include: monoalkylamines, such as n-propylamine and n-butylamine; dialkylamines, such as di-n-butylamine; alkanolamines, such as monoethanolamine and diethanolamine; and monoalcohols, such as ethanol.

The weight average molecular weight (Mw) of the polyurethane resin is preferably 5,000 to 100,000, more preferably 10,000 to 60,000. When the Mw of the polyurethane resin is 5,000 or higher, the cohesive force of a laser marking layer as a film is thereby easily enhanced, so that adhesiveness to a base material and applicability to lamination are easily obtained. When, on the other hand, the Mw of the polyurethane resin is 100,000 or lower, the polyurethane resin thereby dissolves into a solvent easily to make the fluidity of an ink (ink composition) satisfactory, which enables satisfactory printing. From this viewpoint, the Mw of the polyurethane resin is more preferably 80,000 or lower, still more preferably 60,000 or lower. It is to be noted that when the molecular weight, chemical structure, and equivalent ratio of respective components are different, the hardness of a resultant polyurethane resin is also different, and therefore the adhesiveness and anti-blocking property of a laser marking layer to a base material can be adjusted by appropriately combining these components. In the present specification, the weight average molecular weight of the polyurethane resin is a value in terms of polystyrene, the value measured by gel permeation chromatography (GPC).

When further applicability to lamination is required in the case where the ink composition is applied to the previously described base material which is used for a laminate packaging material, the binder resin (A) may contain a vinyl chloride/vinyl acetate copolymer resin together with the above-described polyurethane resin. In addition, also from the viewpoint of the adhesiveness and the like in the case where the ink composition is applied to the previously described PET shrink film which is used for a shrink packaging label, the binder resin (A) may contain a vinyl chloride/vinyl acetate copolymer resin together with the above described polyurethane resin. In these cases, a mixture of a polyurethane resin and a vinyl chloride/vinyl acetate copolymer resin may be used as the binder resin (A). The vinyl chloride/vinyl acetate copolymer resin is obtained by subjecting a monomer component containing vinyl chloride and vinyl acetate to copolymerization.

From the viewpoint of the cohesion force and adhesiveness to a base material of a laser marking layer, and the color developability by irradiation with laser light, the content of the binder resin (A) is preferably 5 to 50% by mass based on the total mass of the solid content in the ink composition. From the viewpoint of obtaining a laser marking layer having moderate cohesion force and adhesiveness, the content of the binder resin (A) in the whole solid content in the ink composition is preferably 5% by mass or more, more preferably 10% by mass or more, and still more preferably 12% by mass or more. On the other hand, from the viewpoint of obtaining a laser marking layer that exhibits satisfactory color developability by irradiation with laser light, the content of the binder resin (A) in the whole solid content in the ink composition is preferably 50% by mass or less, more preferably 30% by mass or less, and still more preferably 25% by mass or less.

Titanium oxide (B) is essential for allowing a laser marking layer to develop color by laser light. In the ink composition of the first aspect, titanium oxide (B) contains at least one selected from the group consisting of titanium oxide (b₁) surface-treated with alumina, titanium oxide (b₂) surface-treated with alumina and silica, and titanium oxide (b₃) coating-treated with antimony-doped tin oxide. Hereinafter, titanium oxide (b₁) will be written as alumina-treated titanium oxide (b₁), titanium oxide (b₂) will be written as alumina-silica composite-treated titanium oxide (b₂), and titanium oxide (b₃) will be written as ATO-treated titanium oxide (b₃) in some cases. In addition, these titanium oxides (b₁, b₂, b₃) will be written together as surface-treated titanium oxide (B_{I}) in some cases.

In the ink composition of the first aspect, the ratio of the content of surface-treated titanium oxide (B_{I}) to the content of the binder resin (A), (B_{I}/A), in the ink composition is set in a range of 2.5 to 6.5 on a solid content mass ratio basis (condition 1). The content of surface-treated titanium oxide (B_{I}) in the ink composition is the total content of alumina-treated titanium oxide (b₁), alumina-silica composite-treated titanium oxide (b₂), and ATO-treated titanium oxide (b₃).

When surface-treated titanium oxide (B_{I}) is used in the condition 1 in the ink composition of the first aspect, a laser marking layer that enables recording with satisfactory visibility can thereby be formed. From the viewpoint of enabling recording with more satisfactory visibility, the ratio, (B_{I}/A), is preferably 2.7 or more, more preferably 3.0 or more, and still more preferably 3.5 or more, and is preferably 6.0 or less on a solid content mass ratio basis.

In surface-treated titanium oxide (B_{I}), alumina-treated titanium oxide (b₁) and ATO-treated titanium oxide (b₃) are preferable. ATO-treated titanium oxide (b₃) is more preferably used because a laser marking layer that enables recording with further satisfactory visibility is easily obtained. Accordingly, when the ink composition contains ATO-treated titanium oxide (b₃), the ratio of the content of ATO-treated titanium oxide (b₃) to the content of the binder resin (A), (b₃/A), is set to 1.0 to 6.5 on a solid content mass ratio basis (condition 2), and thereby a laser marking layer that enables recording with satisfactory visibility can also be formed. From the viewpoint of enabling recording with more satisfactory visibility, the above-described ratio, (b₃/A), is preferably 1.2 or more, more preferably 1.5 or more, and still more preferably 2.0 or more, and is preferably 6.0 or less on a solid content mass ratio basis.

In the ink composition of the first aspect, at least one of the conditions 1 and 2 may be satisfied. For example, when the ink composition does not contain ATO-treated titanium oxide (b₃), but contains any one or both of alumina-treated titanium oxide (b₁) and alumina-silica composite-treated titanium oxide (b₂), the condition 1 may be satisfied. In addition, when the ink composition contains ATO-treated titanium oxide (b₃) singly in the surface-treated titanium oxide (B_{I}), only the condition 2 of the conditions 1 and 2 may be satisfied, or both of the conditions 1 and 2 may be satisfied because if the condition 1 is satisfied, the condition 2 is also satisfied.

Further, when the ink composition contains ATO-treated titanium oxide (b₃) and contains any one or both of alumina-treated titanium oxide (b₁) and alumina-silica composite-treated titanium oxide (b₂), only the condition 1 may be satisfied, only the condition 2 may be satisfied, or both of the conditions 1 and 2 may be satisfied. When the ink composition contains ATO-treated titanium oxide (b₃) and surface-treated titanium oxide (b₁ and/or b₂) other than that, controlling the amount of use of ATO-treated titanium oxide (b₃) to be small in such a way as to satisfy only the condition 1 is preferable in that the ink composition can be made more inexpensive, and a laser marking layer that enables recording with satisfactory visibility can be formed more inexpensively. For example, in this case, the ratio of the content of ATO-treated titanium oxide (b₃) to the content of the binder resin (A), (b₃/A), is preferably set to 0.01 to 0.5, more preferably 0.01 to 0.3, and still more preferably 0.02 to 0.1.

The oil absorption of alumina-treated titanium oxide (b₁) and alumina-silica composite-treated titanium oxide (b₃) is preferably 15 g/100 g or more, more preferably 17 g/100 g or more, and is preferably 55 g/100 g or less. In the present specification, the oil absorption in titanium oxide means the amount (g) of boiled linseed oil absorbed per 100 g of a sample of the titanium oxide. This oil absorption can be measured in accordance with the method specified in JIS K5101-13-2:2004.

In addition, in the ink composition of the second aspect, titanium oxide (B) contains: titanium oxide (b₃) coating-treated with antimony-doped tin oxide; and titanium oxide (b₄) other than titanium oxide (b₃), the titanium oxide (b₄) having an oil absorption of 19 g/100 g or more. The ratio of the total content of ATO-treated titanium oxide (b₃) and titanium oxide (b₄) having an oil absorption of 19 g/100 g or more to the content of the binder resin (A), [(b₃+b₄)/A], in the ink composition is set in a range of 1.0 to 6.5 on a solid content mass ratio basis (condition 3). A laser marking layer that enables recording with satisfactory visibility can also be formed by this constitution (condition 3). From the viewpoint of enabling recording with more satisfactory visibility, the above-described ratio, [(b₃+b₄)/A], is preferably 1.5 or more, more preferably 2.0 or more, and still more preferably 3.0 or more, and is preferably 6.0 or less on a solid content mass ratio basis.

When ATO-treated titanium oxide (b₃) and titanium oxide (b₄) having an oil absorption of 19 g/100 g or more are used in combination in the ink composition of the second aspect, a laser marking layer that enables recording with satisfactory visibility can thereby be formed even if the amount of use of ATO-treated titanium oxide (b₃) is controlled in a small amount. Therefore, the ink composition and the objective laser marking layer can be obtained more inexpensively. In this case, the ratio of the content of ATO-treated titanium oxide (b₃) to the content of the binder resin (A), (b₃/A), is preferably set to 0.01 to 0.5, more preferably 0.01 to 0.3, and still more preferably 0.02 to 0.1. In addition, the ratio of the content of ATO-treated titanium oxide (b₃) to the content of titanium oxide (b₄), (b₃/b₄), is preferably set to 0.01 to 0.2, more preferably 0.01 to 0.1, and still more preferably 0.01 to 0.05.

The titanium oxide (b₄) which can be used in the ink composition of the second aspect is not particularly limited as long as the oil absorption is 19 g/100 g or more, and titanium oxide on which a surface-treatment has not been performed (hereinafter, sometimes written as “surface-untreated titanium oxide”) can also be used in addition to titanium oxide on which a predetermined surface treatment has been performed. The oil absorption of titanium oxide (b₄) is preferably 20 g/100 g or more, and is preferably 55 g/100 g or less.

Examples of titanium oxide which can be used as titanium oxide (b₄) having an oil absorption of 19 g/100 g or more and on which a predetermined surface treatment has been performed include titanium oxide on which a surface treatment, such as an alumina treatment, a silica treatment, a zinc treatment, an alumina-silica composite-treatment, an alumina-silica-zinc composite-treatment, and an organic treatment, has been performed. From the viewpoint of enhancing the effect more by a combination with ATO-treated titanium oxide (b₃), any one or both of the previously described alumina-treated titanium oxide (b₁) and the previously described alumina-silica composite-treated titanium oxide (b₂) each having an oil absorption of 19 g/100 g or more are more preferably used as titanium oxide (b₄).

As described above, in the ink composition according to one embodiment of the present invention, particular titanium oxide (B) is used in a particular amount in a range where at least any one of the conditions 1 to 3 is satisfied. In the case where any of the conditions 1 to 3 is not satisfied due to the fact that the content of titanium oxide (B) in the ink composition is too small, a difference in contrast between a non-color-developing part and a color-developing part at the time when color development is caused by irradiation with laser light is hard to obtain, so that recording with satisfactory visibility is difficult in some cases. On the other hand, in the case where any of the above-described conditions 1 to 3 is not satisfied due to the fact that the content of titanium oxide (B) in the ink composition is too large, the fluidity of the ink composition is impaired to make it difficult to apply the ink composition, so that formation of a laser marking layer is difficult in some cases.

The crystal structure of titanium oxide (B) which is used in the ink composition according to one embodiment of the present invention may be a rutile type or an anatase type, and is more preferably a rutile type. In addition, as titanium oxide (B), titanium oxide produced by a sulfuric acid method may be used, or titanium oxide produced by a chlorine method may be used. The average particle diameter of titanium oxide (B) is preferably 0.15 to 0.50 μm, more preferably 0.18 to 0.40 μm, and still more preferably 0.20 to 0.30 μm. In the present specification, the average particle diameter is a particle diameter at an accumulated value of 50% on a volume basis in the particle size distribution which is determined with a particle size distribution analyzer by a laser diffraction/scattering method.

A commercially available product may be used as each of the above-described titanium oxides (b₁ to b₄). Examples of alumina-treated titanium oxide (b₁) include: “JR-600A” (oil absorption of 19 g/100 g), “JR-600E” (oil absorption of 21 g/100 g), “JR-301” (oil absorption of 18 g/100 g), and “WP0364” (oil absorption of 19 g/100 g), all trade names and manufactured by Tayca Corporation; and “R-630” (oil absorption of 19 g/100 g) and “R-680” (oil absorption of 19 g/100 g), all trade names and manufactured by ISHIHARA SANGYO KAISHA, LTD.

Examples of alumina-silica composite-treated titanium oxide (b₂) include: “JR-707” (oil absorption of 22 g/100 g), “JR-708D” (oil absorption of 21 g/100 g), “JR-800” (oil absorption of 29 g/100 g), and “JR-806” (oil absorption of 21 g/100 g), all trade names and manufactured by Tayca Corporation; and “R-550” (oil absorption of 23 g/100 g), “CR-80” (oil absorption of 20 g/100 g), “CR-90” (oil absorption of 21 g/100 g), and “CR-93” (oil absorption of 20 g/100 g), all trade names and manufactured by ISHIHARA SANGYO KAISHA, LTD.

Examples of ATO-treated titanium oxide (b₃) include “Iriotec 8850” (oil absorption of 50 g/100 g), trade name, manufactured by Merck & Co., Inc. Examples of titanium oxide (b₄) having an oil absorption of 19 g/100 g or more include: products as surface-untreated titanium oxide, such as “JA-1” (oil absorption of 23 g/100 g) and “JA-3” (oil absorption of 23 g/100 g), all trade names and manufactured by Tayca Corporation, and “A-100” (oil absorption of 22 g/100 g), trade name, manufactured by ISHIHARA SANGYO KAISHA, in addition to products as surface-treated titanium oxide (B_{I}) given above as examples and having an oil absorption of 19 g/100 g or more.

From the viewpoint of the cohesion force and adhesiveness to a base material of a laser marking layer, and the color developability by irradiation with laser light, the content of titanium oxide (B) is preferably 50 to 95% by mass based on the total mass of the solid content in the ink composition. From the viewpoint of obtaining a laser marking layer having moderate cohesive force and adhesiveness, the content of titanium oxide (B) in the total solid content in the ink composition is preferably 95% by mass or less, still more preferably 90% by mass or less. On the other hand, from the viewpoint of obtaining a laser marking layer that exhibits satisfactory color developability by irradiation with laser light, the content of titanium oxide (B) in the total solid content in the ink composition is preferably 50% by mass or more, more preferably 60% by mass or more, and still more preferably 70% by mass or more.

The ink composition according to one embodiment of the present invention can usually contain a solvent (C). Examples of a suitable solvent include a ketone-based solvent, a hydrocarbon-based solvent, an ester-based solvent, an alcohol-based solvent, and a glycol ether-based solvent. The solvent to be used can appropriately be selected according to: the material of the base material to be an object of providing the ink composition; the intended use where the base material is used; and the like. The content of the solvent (C) in the ink composition is not particularly limited, and the content of the solvent can be adjusted in such a way that the ink composition has an appropriate viscosity according to the method of printing or the like when a laser marking layer is formed using the ink composition.

Specific examples of the ketone-based solvent include acetone, methyl ethyl ketone, methyl isobutyl ketone, cyclohexanone, methylcyclohexanone, and diacetone alcohol. Specific examples of the hydrocarbon-based solvent include toluene, cyclohexane, methylcyclohexane, ethylcyclohexane, dimethylcyclohexane, cyclopentane, methylcyclopentane, and ethylcyclopentane. Specific examples of the ester-based solvent include ethyl acetate, propyl acetate, and butyl acetate. Specific examples of the alcohol-based solvent include methyl alcohol, ethyl alcohol, propyl alcohol, isopropyl alcohol, and butyl alcohol. Specific examples of the glycol ether-based solvent include ethylene glycol monomethyl ether, ethylene glycol monoethyl ether, propylene glycol monomethyl ether, propylene glycol monoethyl ether, ethylene glycol monomethyl ether acetate, ethylene glycol monoethyl ether acetate, propylene glycol monomethyl ether acetate, and propylene glycol monoethyl ether acetate. One of the solvents can be contained singly in the ink composition, or two or more of the solvents can be contained in combination in the ink composition.

Various additives can be contained in the ink composition. Examples of the additives include a dispersant, a defoamer, a levelling agent, silica, wax, a polyisocyanate-based hardener, a coupling agent, an antioxidizing agent, an ultraviolet ray absorber, a light stabilizer, a surfactant, an antiseptic, an anti-corrosive agent, a plasticizer, a flame retardant, and a developer.

From the viewpoint of easily forming a laser marking layer by providing the ink composition on a base material, the ink composition is preferably prepared as a printing ink. Among the printing inks, the ink composition is more preferably prepared as a gravure printing ink, an offset printing ink, a flexographic printing ink, or a screen printing ink, and is still more preferably prepared as a gravure printing ink from the viewpoint of high quality and high productivity.

The base material to be an object of providing the ink composition (laser marking layer) is not particularly limited, and examples of the material thereof include a plastic, rubber, a ceramic, a metal, wood, and paper. In addition, examples of the intended use where the base material is used include packaging materials including: various packaging containers in which food, beverages, pharmaceuticals, quasi-drugs, cosmetics, detergents, chemicals, and the like are contained as contents; and various packaging materials, such as films and papers. Examples of the intended use where the base material is used further include electronic parts, electric parts, electric products, automobile parts, various sheets and cards, and labels and tags each provided on a product. The ink composition is preferably used for forming a laser marking layer to be provided on a packaging material. Examples of a suitable base material for the intended use include: paper, such as art paper, coated paper, wood-free paper, gravure printing paper, Japanese paper, paperboard, and synthetic paper; a metal foil such as an aluminum foil; a plastic film; and laminated bodies of one, or two or more of these. A base material that transmits laser light to be used, such as a plastic film, is more preferably used as a base material.

Examples of the plastic film include: polyester films, such as polyethylene terephthalate (PET), amorphous polyethylene terephthalate (A-PET), polybutylene terephthalate (PBT), polyethylene naphthalate (PEN), and polylactic acid; polyolefin films, such as low density polyethylene (LDPE), linear low density polyethylene (LLDPE), high density polyethylene (HDPE), and polypropylene (PP); cellulose films, such as cellophane; polystyrene (PS) films; ethylene-vinyl acetate copolymer resin films; ethylene-vinyl alcohol copolymer resin films; polyamide films; polycarbonate films; polyimide films; and polyvinylchloride films. For example, any of stretched plastic films and non-stretched plastic films, such as a biaxially stretched PP film and a non-stretched PP film, can be used. In addition, a plastic film provided with a layer of metal deposition, such as aluminum deposition; a plastic film provided with a transparent deposited layer of silica and alumina, or the like; and the like can also be used. Further, various surface treatments, such as a corona discharge treatment, a plasma treatment, a flame treatment, a solvent treatment, and a coating treatment; various kinds of decoration, such as decoration by printing or the like using a colored ink; and the like may be performed on the surface of the plastic film.

As laser light with which a laser marking layer, which is formed from the ink composition, is irradiated, laser light that is usable for so-called laser printing can be used. Examples of suitable laser light include YAG laser (wavelength: 1064 nm), YVO₄ laser (wavelength: 1064 nm), fiber laser (wavelength: 1050 to 1090 nm), green laser (wavelength: 532 nm), and UV laser (wavelength: 355 nm). The ink composition is preferably for laser marking using any one of these types of laser light, and is more preferably for laser marking using any one or both of YVO₄ laser and fiber laser.

<Packaging Material>

A packaging material according to one embodiment of the present invention is provided with: a base material; and a laser marking layer provided on the base material. The laser marking layer in the packaging material is formed from the previously described laser marking ink composition. The packaging material may be provided with an arbitrary layer other than the base material and the laser marking layer. Examples of the arbitrary layer include, but not limited to, a pattern layer, a colored layer, a protective layer, a deposited layer, and an adhesive layer. In addition, the laser marking layer in the packaging material may be directly provided on the surface of the base material, or may be provided on the surface of the base material through an arbitrary layer, such as, for example, a pattern layer or a colored layer.

The laser marking layer in the packaging material is formed from the previously described laser marking ink composition. Therefore, the laser marking layer contains a binder resin (A) and particular titanium oxide (B) under a condition where at least any one of the previously described conditions 1 to 3 is satisfied. The thickness of the laser marking layer is preferably 0.1 to 100 μm, more preferably 0.5 to 20 μm, and still more preferably 1 to 5 μm.

The laser marking layer is preferably formed as a white background having a whitish hue by containing titanium oxide (B) and preferably causes development of a color of a blackish hue by irradiation with laser light in the white background. When laser marking is performed on such a laser marking layer, contrast thereby becomes clearer, so that recording with more satisfactory visibility can be obtained.

As the base material in the packaging material, paper, a metal foil, and a plastic film, and laminated bodies of one, or two or more of these are preferable as described previously, more preferably, the previously described various plastic films. The thickness of the base material is preferably 5 to 500 μm, more preferably 10 to 100 μm, and still more preferably 10 to 60 μm.

Examples of the specific forms of the packaging material include paper boxes, packaging paper, packaging films, packaging labels, packaging bags, and plastic containers such as plastic cases and plastic bottles. In addition, examples of the suitable intended use of the packaging material include packaging materials for food, packaging materials for beverages, packaging materials for pharmaceuticals, packaging materials for quasi-drugs, and packaging materials for cosmetics, and among these, packaging materials for food and packaging materials for beverages are more suitable. More specifically, laminate packaging materials, trays for food, and the like which are each used as a packaging material for food, and shrink packaging labels and the like which are each used as a packaging material for food or a packaging material for beverages are still more suitable.

In the case of a laminate packaging material, a protective layer (sealant film) is preferably provided on the side of the surface opposite to the side of the base material in the laser marking layer. Such a laminate packaging material has a laminated structure provided with at least: a base material; a laser marking layer; and a protective layer in the mentioned order. Peeling-off, wear, and the like of the laser marking layer can be prevented by the protective layer when laser marking is performed on the packaging material, when the packaging material is produced, when the packaging material is used, and so on. For the protective layer, for example, the same resin materials as given in the description of the previously described binder resins and the same resin materials as given in the description of the previously described plastic films can be used. In addition, the previously described base materials themselves can also be used. The protective layer may be directly provided on the laser marking layer, or may be provided on the laser marking layer through an anchor coat agent, an adhesive, or the like. The thickness of the protective layer is preferably 1 to 300 μm, more preferably 5 to 200 μm, and still more preferably 10 to 100 μm.

The method for producing the packaging material includes a step of forming a laser marking layer by providing the previously described ink composition on a base material. This production method preferably includes a step of preparing the ink composition prior to the step of forming the laser marking layer.

The step of preparing the ink composition more preferably includes: a step (milling step) of milling the binder resin (A), titanium oxide (B), the solvent (C), and an additive which is used as necessary; and a step of diluting the milled ink composition with a solvent, thereby obtaining a diluted ink. In the step of preparing the ink composition, for example, a paint shaker, a roll mill (triple roll), a ball mill, a sand mill, and an attritor, and other stirring apparatuses, dispersion apparatuses, etc. can be used.

Examples of the method for providing the ink composition on the base material in the step of forming the laser marking layer on the base material include methods such as printing, dipping, and spin coating. From the viewpoint of easily forming the laser marking layer by providing the ink composition on the base material, the ink composition is preferably printed on the base material. The formation of the laser marking layer through printing is more preferably performed through gravure printing, offset printing, flexographic printing, or screen printing from the viewpoint of high quality and high productivity, and the formation of the laser marking layer through printing is still more preferably performed through gravure printing. The laser marking layer may be provided on the entire surface on the base material, or may be provided at a part including a desired position where the laser marking is performed. In the step of forming the laser marking layer on the base material, a step of drying the ink composition; a step of curing the binder resin (A) in the ink layer; or the like can be performed after the ink composition is printed on the base material.

When the previously described laminate packaging material is produced, it is preferable that the production method further include a step of providing a protective layer on the side of the surface opposite to the side of the base material in the laser marking layer. Examples of the method for providing the protective layer include a method in which, for example, a liquid composition containing the above-described resin material for forming the protective layer is applied on the side of the surface opposite to the side of the base material in the laser marking layer and curing the applied liquid composition to form a protective layer. Examples of the type of curing of the liquid composition include: curing by drying, heat, or the like; and curing through irradiation with an activate energy ray such as an ultraviolet ray. In addition, the protective layer can also be formed in such a way that, for example, an anchor coat agent is applied on the side of the surface opposite to the side of the base material in the laser marking layer to dry the applied anchor coat agent, and thereafter the above-described resin material (such as, for example, LDPE, HDPE, and PP) is provided by melt extrusion lamination. Further, the protective layer can also be formed by dry lamination in which, for example, an adhesive is applied on the side of the surface opposite to the side of the base material in the laser marking layer to dry the applied adhesive, and thereafter the previously described paper, metal foil, plastic film, or the like is pasted thereto.

By irradiating the laser marking layer in the packaging material with laser light, color development is caused in the laser marking layer, so that laser marking can be performed. Examples of suitable laser light include YAG laser, YVO₄ laser, fiber laser, green laser, and UV laser. At least one of these types of laser light is preferably used, and laser light of any one of YVO₄ laser and fiber laser, or laser light in which both of YVO₄ laser and fiber laser are combined is more preferably used.

Further, when the laser light of any one of YVO₄ laser and fiber laser, or the laser light in which both of YVO₄ laser and fiber laser are combined is used, the condition is further preferably such that the scan speed is set to 500 to 4000 mm/sec (more preferably 800 to 3000 mm/sec), the average output is set to 1 to 30 W (more preferably 1 to 10 W), and the pulse frequency is set to 5 to 150 kHz (more preferably 10 to 50 kHz).

Examples of the types of marks marked by laser marking include a character, a figure, a pattern, a bar code, and a two-dimensional code. In addition, examples of the information denoted by these marks include a trade name, a manufacturer's name, a date of production, a best before date, an expiration date, a use-by date, a sell-by date, a lot number, a serial number, a raw material, a component, a trade mark, and a design.

As described above in detail, the laser marking ink composition and the packaging material each according to one embodiment of the present invention can be constituted as follows.

[1] A laser marking ink composition to be used for forming a laser marking layer, the ink composition comprising: a binder resin (A); and titanium oxide (B) that causes color development in the laser marking layer by irradiation with laser light, wherein the titanium oxide (B) comprises at least one surface-treated titanium oxide (B_{I}) selected from the group consisting of titanium oxide (b₁) surface-treated with alumina, titanium oxide (b₂) surface-treated with alumina and silica, and titanium oxide (b₃) coating-treated with antimony-doped tin oxide, and at least one of the following conditions 1 and 2 is satisfied.

Condition 1: a ratio of a content of the surface-treated titanium oxide (B_{I}) to a content of the binder resin (A), (B_{I}/A), is 2.5 to 6.5 on a solid content mass ratio basis.

Condition 2: the titanium oxide (B) comprises at least the titanium oxide (b₃), and a ratio of a content of the titanium oxide (b₃) to a content of the binder resin (A), (b₃/A), is 1.0 to 6.5 on a solid content mass ratio basis.

[2] The laser marking ink composition according to [1], wherein the titanium oxide (b₁) surface-treated with alumina and the titanium oxide (b₂) surface-treated with alumina and silica each have an oil absorption of 15 to 55 g/100 g.

[3] A laser marking ink composition to be used for forming a laser marking layer, the ink composition comprising: a binder resin (A); and titanium oxide (B) that causes color development in the laser marking layer by irradiation with laser light, wherein the titanium oxide (B) comprises: titanium oxide (b₃) coating-treated with antimony-doped tin oxide; and titanium oxide (b₄) other than the titanium oxide (b₃), the titanium oxide (b₄) having an oil absorption of 19 g/100 g or more, and a ratio of a total content of the titanium oxide (b₃) and the titanium oxide (b₄) to a content of the binder resin (A), [(b₃+b₄)/A], is 1.0 to 6.5 on a solid content mass ratio basis.

[4] The laser marking ink composition according to [3], wherein the titanium oxide (b₄) having an oil absorption of 19 g/100 g or more comprises any one or both of titanium oxide (b₁) surface-treated with alumina and titanium oxide (b₂) surface-treated with alumina and silica.

[5] The laser marking ink composition according to any one of [1] to [4], wherein the binder resin (A) comprises any one or both of a polyurethane resin and an acrylic resin.

[6] A packaging material comprising: a base material; and a laser marking layer provided on the base material, wherein the laser marking layer is formed with the laser-marking ink composition according to any one of [1] to [5].

### EXAMPLES

Hereinafter, the ink composition according to one embodiment of the present invention will be more specifically described giving Examples and Comparative Examples, but the ink composition is not limited to the following Examples. It is to be noted that in the description below, “part(s)” and “%” are each on a mass basis (“part(s) by mass” and “% by mass”, respectively) unless otherwise noted.

### Test Example A

In Test Example A, ink compositions were prepared under the supposition that the ink compositions were applied to a laminate packaging material, laminate printed matters were prepared using the prepared ink compositions, and laser marking was performed on the resultant laminate printed matters to evaluate the visibility.

[Preparation of Binder Resin]

As a binder resin to be contained in the ink compositions, a polyurethane resin solution (trade name “TA24-241L”, manufactured by Hitachi Chemical Company, Ltd., viscosity: 1,000 mPa·s, contained solvents: ethyl acetate and isopropyl alcohol, glass transition point: −51° C., weight average molecular weight: 40,000) having a solid content of 30% was used.

### Preparation of Ink Compositions

### Example A1

An ink composition A1 was obtained by mixing 50.0 parts of alumina-silica composite-treated titanium oxide (trade name “JR-707”, manufactured by Tayca Corporation, crystal: rutile type, oil absorption: 22 g/100 g; hereinafter, written as “titanium oxide 1”), 30.0 parts (9.0 parts as solid content) of the polyurethane resin solution, and 20.0 parts of a mixed solvent containing ethyl acetate/isopropyl alcohol in a volume ratio of 4/1, and milling the mixture with a paint shaker.

### Example A2

An ink composition A2 was obtained in the same manner as in the preparation of the ink composition A1, except that titanium oxide 1 used in the ink composition A1 was changed to another alumina-silica composite-treated titanium oxide (trade name “JR-708D”, manufactured by Tayca Corporation, crystal: rutile type, oil absorption: 21 g/100 g; hereinafter, written as “titanium oxide 2”).

### Example A3

An ink composition A3 was obtained in the same manner as in the preparation of the ink composition A1, except that titanium oxide 1 used in the ink composition A1 was changed to another alumina-silica composite-treated titanium oxide (trade name “JR-800”, manufactured by Tayca Corporation, crystal: rutile type, oil absorption: 29 g/100 g; hereinafter, written as “titanium oxide 3”).

### Example A4

An ink composition A4 was obtained in the same manner as in the preparation of the ink composition A1, except that titanium oxide 1 used in the ink composition A1 was changed to another alumina-silica composite-treated titanium oxide (trade name “JR-806”, manufactured by Tayca Corporation, crystal: rutile type, oil absorption: 21 g/100 g; hereinafter, written as “titanium oxide 4”).

### Example A5

An ink composition A5 was obtained in the same manner as in the preparation of the ink composition A1, except that titanium oxide 1 used in the ink composition A1 was changed to alumina-treated titanium oxide (trade name “JR-600A”, manufactured by Tayca Corporation, crystal: rutile type, oil absorption: 19 g/100 g; hereinafter, written as “titanium oxide 5”).

### Example A6

An ink composition A6 was obtained in the same manner as in the preparation of the ink composition A1, except that titanium oxide 1 used in the ink composition A1 was changed to alumina-treated titanium oxide (trade name “JR-600E”, manufactured by Tayca Corporation, crystal: rutile type, oil absorption: 21 g/100 g; hereinafter, written as “titanium oxide 6”).

### Example A7

An ink composition A7 was obtained in the same manner as in the preparation of the ink composition A1, except that titanium oxide 1 used in the ink composition A1 was changed to alumina-treated titanium oxide (trade name “WP0364”, manufactured by Tayca Corporation, crystal: rutile type, oil absorption: 19 g/100 g; hereinafter, written as “titanium oxide 7”).

### Example A8

An ink composition A8 was obtained in the same manner as in the preparation of the ink composition A1, except that titanium oxide 1 used in the ink composition A1 was changed to alumina-treated titanium oxide (trade name “JR-301”, manufactured by Tayca Corporation, crystal: rutile type, oil absorption: 18 g/100 g; hereinafter, written as “titanium oxide 8”).

### Example A9

An ink composition A9 was obtained in the same manner as in the preparation of the ink composition A1, except that titanium oxide 1 used in the ink composition A1 was changed to ATO-treated titanium oxide (trade name “Iriotec 8850”, manufactured by Merck & Co., Inc., crystal: rutile type, oil absorption: 50 g/100 g; hereinafter, written as “titanium oxide 9”).

### Example A10

An ink composition A10 was obtained in the same manner as in the preparation of the ink composition A1, except that the amounts of titanium oxide 1 and the mixed solvent used in the ink composition A1 (50.0 parts and 20.0 parts, respectively) were changed to 27.0 parts and 43.0 parts, respectively.

### Example A11

An ink composition A11 was obtained in the same manner as in the preparation of the ink composition A1, except that the amounts of titanium oxide 1 and the mixed solvent used in the ink composition A1 (50.0 parts and 20.0 parts, respectively) were changed to 54.0 parts and 16.0 parts, respectively.

### Example A12

An ink composition A12 was obtained in the same manner as in the preparation of the ink composition A1, except that the amounts of titanium oxide 1 and the mixed solvent used in the ink composition A1 (50.0 parts and 20.0 parts, respectively) were changed to 35.0 parts and 35.0 parts, respectively.

### Example A13

An ink composition A13 was obtained by mixing 35.0 parts of the titanium oxide 1, 0.4 parts of the titanium oxide 9, 30.0 parts (9.0 parts as solid content) of the polyurethane resin solution, and 34.6 parts of the mixed solvent, and milling the mixture with a paint shaker.

### Example A14

An ink composition A14 was obtained by mixing 15.0 parts of the titanium oxide 1, 0.2 parts of the titanium oxide 9, 30.0 parts (9.0 parts as solid content) of the polyurethane resin solution, and 54.8 parts of the mixed solvent, and milling the mixture with a paint shaker.

### Example A15

An ink composition A15 was obtained by mixing 0.5 parts of the titanium oxide 9, 50.0 parts of surface-untreated titanium oxide (trade name “JA-1”, manufactured by Tayca Corporation, crystal: anatase type, oil absorption: 23 g/100 g; hereinafter, written as “titanium oxide 10”), 30.0 parts (9.0 parts as solid content) of the polyurethane resin solution, and 19.5 parts of the mixed solvent, and milling the mixture with a paint shaker.

### Example A16

An ink composition A16 was obtained by mixing 9.0 parts of the titanium oxide 9, 30.0 parts (9.0 parts as solid content) of the polyurethane resin solution, and 61.0 parts of the mixed solvent, and milling the mixture with a paint shaker.

### Comparative Example A17

An ink composition A17 was obtained in the same manner as in the preparation of the ink composition A1, except that the amounts of titanium oxide 1 and the mixed solvent used in the ink composition A1 (50.0 parts and 20.0 parts, respectively) were changed to 15.0 parts and 55.0 parts, respectively.

### Comparative Example A18

An ink composition A18 was obtained in the same manner as in the preparation of the ink composition A1, except that the amounts of titanium oxide 1 and the mixed solvent used in the ink composition A1 (50.0 parts and 20.0 parts, respectively) were changed to 22.0 parts and 48.0 parts, respectively.

### Comparative Example A19

An ink composition A19 was obtained in the same manner as in the preparation of the ink composition A1, except that the amounts of titanium oxide 1 and the mixed solvent used in the ink composition A1 (50.0 parts and 20.0 parts, respectively) were changed to 60.0 parts and 10.0 parts, respectively.

### Comparative Example A20

An ink composition A20 was obtained in the same manner as in the preparation of the ink composition A1, except that titanium oxide 1 used in the ink composition A1 was changed to the titanium oxide 10.

### Comparative Example A21

An ink composition A21 was obtained in the same manner as in the preparation of the ink composition A1, except that titanium oxide 1 used in the ink composition A1 was changed to surface-untreated titanium oxide (trade name “JR”, manufactured by Tayca Corporation, crystal: rutile type, oil absorption: 18 g/100 g; hereinafter, written as “titanium oxide 11”).

### Comparative Example A22

An ink composition A22 was obtained by mixing 60.0 parts of the titanium oxide 1, 0.6 parts of the titanium oxide 9, 30.0 parts (9.0 parts as solid content) of the polyurethane resin solution, and 9.4 parts of the mixed solvent, and milling the mixture with a paint shaker.

### Comparative Example A23

An ink composition A23 was obtained by mixing 50.0 parts of the titanium oxide 11, 0.5 parts of the titanium oxide 9, 30.0 parts (9.0 parts as solid content) of the polyurethane resin solution, and 19.5 parts of the mixed solvent, and milling the mixture with a paint shaker.

### Comparative Example A24

An ink composition A24 was obtained by mixing 8.0 parts of the titanium oxide 9, 30.0 parts (9.0 parts as solid content) of the polyurethane resin solution, and 61 parts of the mixed solvent, and milling the mixture with a paint shaker.

<Evaluation>

As described below, a laminate printed matter was prepared after preparing a diluted ink for each of the ink compositions obtained in the Test Example A, and laser marking was performed on the laminate printed matter to evaluate the visibility of laser marking.

[Preparation of Diluted Inks A1 to 24]

Further, the resultant ink compositions A1 to 24 were each diluted with a dilution solvent of ethyl acetate (60%)/propyl acetate (20%)/isopropyl alcohol (20%) to adjust the viscosity to 18 sec at 25° C. in terms of Zahn cup No. 3 (manufactured by RIGO CO., LTD.), and thus diluted inks A1 to 24 were obtained.

[Preparation of Laminate Printed Matters A1 to 24]

After a printed matter was prepared for each of the resultant diluted inks A1 to 24, laminate printed matters A1 to 24 were prepared. Specifically, gravure printing was performed on the side of the treated surface of a corona discharge-treated PET film (trade name “ESTER E5102”, manufactured by Toyobo Co., Ltd., thickness of 25 μm) as a base material film with a diluted ink using a gravure plate having a plate depth of 35 μm. In this way, printed matters each having an ink layer (solid printed layer of 100 mm×150 mm, thickness of 3 μm) formed on the base material film with each diluted ink were obtained. Thereafter, a polyethylene imine-based anchor coat agent (“SEIKADYNE 4100”, manufactured by Dainichiseika Color & Chemicals Mfg. Co., Ltd.) was applied on the side of the ink layer of each printed matter and the applied anchor coat agent was dried to form an anchor coat layer (thickness of 0.03 μm). Subsequently, LDPE (trade name “Novatec LC600A”, manufactured by Japan Polyethylene Corporation) was melt-extruded as an intermediate layer on the anchor coat layer, and a LLDPE film (trade name “T.U.X FC-D”, manufactured by Mitsui Chemicals Tohcello, Inc.) was laminated thereon. In this way, laminate printed matters each having protective layers (thickness of about 60 μm in total) composed of a LDPE layer (thickness of about 30 μm) and a LLDPE layer (thickness of 30 μm) laminated on the ink layer provided on the base material film in each of the printed matters were obtained.

[Performing Laser Marking]

Laser marking was performed on each of the resultant laminate printed matters A1 to 24 to obtain recorded matters A1 to 24. Specifically, the region where the ink layer was provided in the laminate printed matters was irradiated with laser light having a wavelength of 1060 to 1070 nm from the side of the PET film in the laminate printed matters using a YVO₄/fiber hybrid laser marker (trade name “MD-X1000”, manufactured by KEYENCE CORPORATION) to obtain recorded matters. Recording was performed using “2017.09.01” (height of characters: 5 mm) in lightface and boldface each as an irradiation pattern by the laser marker. With respect to the condition for irradiation with the laser marker, the scan speed was set to 1000 mm/sec; the pulse frequency was set to 20 kHz for both patterns; the average output for the irradiation pattern in lightface was set to 2.6 W; and the average output for the irradiation pattern in boldface was set to 1.3 W. The visibility of the recorded characters (numerals) was evaluated for the resultant recorded matters A1 to 24 in the manner as described below.

(Visibility)

The characters (numerals) of “2017.09.01” in the recorded matters A1 to 24 were checked visually to evaluate the sharpness of the characters according to the evaluation criteria (AA to E) described below taking the extent of blurs and density of the characters into consideration. In the evaluation criteria described below, “AA”, “A”, and “B” were each regarded as a practically usable level, and “C”, “D”, and “E” were each regarded as a practically unusable level.

AA: Remarkable blur does not occur, the characters are deep in color, and the numerals can be recognized very clearly.
A: Remarkable blur does not occur, the characters are not too faint, and the numerals can be recognized clearly.
B: The characters blur, and a faint part exists in the characters, but the characters can be recognized.
C: Majority of the characters blur and are very faint, and therefore it is difficult to recognize the characters.
D: The characters are hardly recorded, so that the characters cannot be recognized.
E: Print itself with the ink blurs, so that characters cannot be recognized.

Table 1-1 and Table 1-2 show: the amounts of the solid components used, the previously described ratios of the content of particular titanium oxide (B) to the content of the binder resin (A), (B_{I}/A, b₃/A, and (b₃+b₄)/A), the ratio of the content of ATO-treated titanium oxide (b₃) to the content of titanium oxide (b₄), (b₃/b₄), each in the ink compositions prepared in respective Examples in Test Example A; and evaluation results of the visibility. It is to be noted that in the following Tables, the ratio (B_{I}/A or b₃/A) is denoted as “-” when an ink composition does not contain titanium oxide (B_{I} or b₃, respectively) to be an object of calculating the ratio. In addition, in the following Tables, the ratios ((b₃+b₄)/A and b₃/b₄) are each denoted as “-” when an ink composition does not contain a combination of titanium oxides (b₃) and (b₄) each to be an object of calculating the ratios. Further, in the uppermost row in the following Tables, the number that is common to the inks (ink composition and diluted ink), printed matters (including laminate printed matter), and a recorded matter each prepared and used in each Example is shown together with the other items.

TABLE 1-1

| | | Example | | | | | | | | | | | |
|---|---|---|---|---|---|---|---|---|---|---|---|---|---|
| | | A1 | A2 | A3 | A4 | A5 | A6 | A7 | A8 | A9 | A10 | A11 | A12 |
| Ink, printed matter, and recorded matter | | A1 | A2 | A3 | A4 | A5 | A6 | A7 | A8 | A9 | A10 | A11 | A12 |
| number | | | | | | | | | | | | | |
| Amount of solid | Polyurethane resin | 9.0 | 9.0 | 9.0 | 9.0 | 9.0 | 9.0 | 9.0 | 9.0 | 9.0 | 9.0 | 9.0 | 9.0 |
| content used in ink | Titanium oxide 1 | 50.0 | | | | | | | | | 27.0 | 54.0 | 35.0 |
| (parts) | Titanium oxide 2 | | 50.0 | | | | | | | | | | |
| | Titanium oxide 3 | | | 50.0 | | | | | | | | | |
| | Titanium oxide 4 | | | | 50.0 | | | | | | | | |
| | Titanium oxide 5 | | | | | 50.0 | | | | | | | |
| | Titanium oxide 6 | | | | | | 50.0 | | | | | | |
| | Titanium oxide 7 | | | | | | | 50.0 | | | | | |
| | Titanium oxide 8 | | | | | | | | 50.0 | | | | |
| | Titanium oxide 9 | | | | | | | | | 50.0 | | | |
| | Titanium oxide 10 | | | | | | | | | | | | |
| | Titanium oxide 11 | | | | | | | | | | | | |

| | | | | | | | | | | | | |
|---|---|---|---|---|---|---|---|---|---|---|---|---|
| B_{I}/A | 5.6 | 5.6 | 5.6 | 5.6 | 5.6 | 5.6 | 5.6 | 5.6 | 5.6 | 3.0 | 6.0 | 3.9 |
| b₃/A | — | — | — | — | — | — | — | — | 5.6 | — | — | — |
| (b₃ + b₄ ) /A | — | — | — | — | — | — | — | — | — | — | — | — |
| b₃/b₄ | — | — | — | — | — | — | — | — | — | — | — | — |
| Visibility (lightface) | B | B | B | B | A | A | A | A | AA | B | A | B |
| Visibility (Boldface) | B | B | B | B | A | A | A | A | AA | B | A | B |

TABLE 1-2

| | | Example | | | | Comparative Example | | | | | | | |
|---|---|---|---|---|---|---|---|---|---|---|---|---|---|
| | | A13 | A14 | A15 | A16 | A17 | A18 | A19 | A20 | A21 | A22 | A23 | A24 |
| Ink, printed matter, and recorded matter | | A13 | A14 | A15 | A16 | A17 | A18 | A19 | A20 | A21 | A22 | A23 | A24 |
| number | | | | | | | | | | | | | |
| Amount of solid | Polyurethane resin | 9.0 | 9.0 | 9.0 | 9.0 | 9.0 | 9.0 | 9.0 | 9.0 | 9.0 | 9.0 | 9.0 | 9.0 |
| content used in ink | Titanium oxide 1 | 35.0 | 15.0 | | | 15.0 | 22.0 | 60.0 | | | 60.0 | | |
| (parts) | Titanium oxide 2 | | | | | | | | | | | | |
| | Titanium oxide 3 | | | | | | | | | | | | |
| | Titanium oxide 4 | | | | | | | | | | | | |
| | Titanium oxide 5 | | | | | | | | | | | | |
| | Titanium oxide 6 | | | | | | | | | | | | |
| | Titanium oxide 7 | | | | | | | | | | | | |
| | Titanium oxide 8 | | | | | | | | | | | | |
| | Titanium oxide 9 | 0.4 | 0.2 | 0.5 | 9.0 | | | | | | 0.6 | 0.5 | 8.0 |
| | Titanium oxide 10 | | | 50.0 | | | | | 50.0 | | | | |
| | Titanium oxide 11 | | | | | | | | | 50.0 | | 50.0 | |

| | | | | | | | | | | | | |
|---|---|---|---|---|---|---|---|---|---|---|---|---|
| B_{I}/A | 3.9 | 1.7 | 0.056 | 1.0 | 1.7 | 2.4 | 6.7 | — | — | 6.7 | 0.056 | 0.9 |
| b₃/A | 0.011 | 0.022 | 0.056 | 1.0 | — | — | — | — | — | 0.067 | 0.056 | 0.9 |
| (b₃ + b₄)/A | 3.9 | 1.7 | 5.6 | — | — | — | — | — | — | 6.7 | — | — |
| b₃/b₄ | 0.011 | 0.013 | 0.010 | — | — | — | — | — | — | 0.010 | — | |
| Visibility (lightface) | A | B | B | B | D | C | E | C | E | E | E | C |
| Visibility (boldface) | A | B | B | B | D | C | E | C | E | E | E | C |

From the comparison between Examples A1 to 13 and Comparative Examples A17 to 21, it was ascertained that a laser marking layer that enables recording with satisfactory visibility can be formed with the ink composition containing surface-treated titanium oxides (B_{I}) and having a ratio of the content of surface-treated titanium oxides (B_{I}) to the content of the binder resin (A), (B_{I}/A), within a range of 2.5 to 6.5 on a solid content mass ratio basis.

In addition, from the results of Example A9, it was ascertained that when ATO-treated titanium oxide (b₃) is used as surface-treated titanium oxides (B_{I}), a laser marking layer that enables recording with more satisfactory visibility can be formed. The present inventors conducted further supporting experiments based on this result, and as a result, it was recognized that a laser marking layer that enables recording with satisfactory visibility can be formed with the ink composition having a ratio of the content of ATO-treated titanium oxide (b₃) to the content of the binder resin (A), (b₃/A), within a range of 1.0 to 6.5 on a solid content mass ratio basis (see Examples A9 and A16, and Comparative Example A24).

Further, from the comparison between Examples A13 to 15 and Comparative Examples A22 to 23, it was recognized that a laser marking layer that enables recording with satisfactory visibility can be formed with the ink composition containing: ATO-treated titanium oxide (b₃); and titanium oxide (b₄) having an oil absorption of 19 g/100 g or more, and having a ratio of the total content of titanium oxide (b₃) and titanium oxide (b₄) to the content of the binder resin (A), [(b₃+b₄)/A], within a range of 1.0 to 6.5 on a solid content mass ratio basis. When a combination of ATO-treated titanium oxide (b₃) and titanium oxide (b₄) having an oil absorption of 19 g/100 g or more is used, it can thereby be expected that even when the amount of use of ATO-treated titanium oxide (b₃) is controlled in a small amount, satisfactory effects are obtained, so that the ink composition and the laser marking layer to be an object are obtained more inexpensively.

### Test Example B

In Test Example B, ink compositions were prepared under the supposition that the ink compositions were applied to a shrink packaging label which is utilized for a PET bottle or the like, each of the prepared ink compositions was printed on a shrink film as a base material, and laser marking was performed on resultant printed matters to evaluate the visibility.

[Preparation of Binder Resins]

As binder resins to be contained in the ink compositions, the polyurethane resin solution having a solid content of 30%, which was used in Example A described above, and a nitrocellulose resin solution having a solid content of 20% were used. As the nitrocellulose resin solution, a nitrocellulose resin solution obtained by dissolving 20.0 parts of a nitrocellulose resin (trade name “DLX30-50”, manufactured by Inabata & Co., Ltd.) in 80.0 parts of a solvent obtained by mixing isopropyl alcohol and ethyl acetate in equal amounts on a volume basis was used.

### Preparation of Ink Compositions

### Example B1

An ink composition B1 was obtained by mixing 50.0 parts of the titanium oxide 1, which is alumina-silica composite-treated titanium oxide, 7.5 parts of the polyurethane resin solution in terms of the solid content (25.0 parts as solution), 2.5 parts of the nitrocellulose resin solution in terms of the solid content (12.5 parts as solution), and 12.5 parts of a mixed solvent containing methyl ethyl ketone/ethyl acetate/isopropyl alcohol in a volume ratio of 5/3/2, and milling the mixture with a paint shaker.

### Example B2

An ink composition B2 was obtained in the same manner as in the preparation of the ink composition B1, except that the amounts of titanium oxide 1 and the mixed solvent used in the ink composition B1 (50.0 parts and 12.5 parts, respectively) were changed to 40.0 parts and 22.5 parts, respectively.

### Example B3

An ink composition B3 was obtained in the same manner as in the preparation of the ink composition B1, except that the amounts of titanium oxide 1 and the mixed solvent used in the ink composition B1 (50.0 parts and 12.5 parts, respectively) were changed to 60.0 parts and 2.5 parts, respectively.

### Example B4

An ink composition B4 was obtained in the same manner as in the preparation of the ink composition B1, except that titanium oxide 1 used in the ink composition B1 was changed to the titanium oxide 2, which is another alumina-silica composite-treated titanium oxide.

### Example B5

An ink composition B5 was obtained in the same manner as in the preparation of the ink composition B1, except that titanium oxide 1 used in the ink composition B1 was changed to the titanium oxide 5, which is alumina-treated titanium oxide.

### Example B6

An ink composition B6 was obtained in the same manner as in the preparation of the ink composition B1, except that titanium oxide 1 used in the ink composition B1 was changed to the titanium oxide 6, which is alumina-treated titanium oxide.

### Example B7

An ink composition B7 was obtained in the same manner as in the preparation of the ink composition B1, except that titanium oxide 1 used in the ink composition B1 was changed to the titanium oxide 9, which is ATO-treated titanium oxide.

### Example B8

An ink composition B8 was obtained by mixing 50.0 parts of the titanium oxide 1, 2.5 parts of the titanium oxide 9, 7.5 parts of the polyurethane resin solution in terms of the solid content (25.0 parts as solution), 2.5 parts of the nitrocellulose resin solution in terms of the solid content (12.5 parts as solution), and 10.0 parts of a mixed solvent containing methyl ethyl ketone/ethyl acetate/isopropyl alcohol in a volume ratio of 5/3/2, and milling the mixture with a paint shaker.

### Example B9

An ink composition B9 was obtained in the same manner as in the preparation of the ink composition B8, except that the amounts of titanium oxide 9 and the mixed solvent used in the ink composition B8 (2.5 parts and 10.0 parts, respectively) were changed to 1.0 part and 11.5 parts, respectively.

### Example B10

An ink composition B10 was obtained in the same manner as in the preparation of the ink composition B8, except that the amounts of titanium oxide 9 and the mixed solvent used in the ink composition B8 (2.5 parts and 10.0 parts, respectively) were changed to 0.5 parts and 12.0 parts, respectively.

### Example B11

An ink composition B11 was obtained in the same manner as in the preparation of the ink composition B8, except that the amounts of titanium oxide 9 and the mixed solvent used in the ink composition B8 (2.5 parts and 10.0 parts, respectively) were changed to 0.2 parts and 12.3 parts, respectively.

### Example B12

An ink composition B12 was obtained by mixing 40.0 parts of the titanium oxide 1, 0.5 parts of the titanium oxide 9, 7.5 parts of the polyurethane resin solution in terms of the solid content (25.0 parts as solution), 2.5 parts of the nitrocellulose resin solution in terms of the solid content (12.5 parts as solution), and 22.0 parts of a mixed solvent containing methyl ethyl ketone/ethyl acetate/isopropyl alcohol in a volume ratio of 5/3/2, and milling the mixture with a paint shaker.

### Example B13

An ink composition B13 was obtained in the same manner as in the preparation of the ink composition B12, except that the amounts of titanium oxide 1 and the mixed solvent used in the ink composition B12 (40.0 parts and 22.0 parts, respectively) were changed to 30.0 parts and 32.0 parts, respectively.

### Example B14

An ink composition B14 was obtained in the same manner as in the preparation of the ink composition B12, except that the amounts of titanium oxide 1 and the mixed solvent used in the ink composition B12 (40.0 parts and 22.0 parts, respectively) were changed to 20.0 parts and 42.0 parts, respectively.

### Comparative Example B15

An ink composition B15 was obtained in the same manner as in the preparation of the ink composition B1, except that the amounts of titanium oxide 1 and the mixed solvent used in the ink composition B1 (50.0 parts and 12.5 parts, respectively) were changed to 20.0 parts and 42.5 parts, respectively.

### Comparative Example B16

An ink composition B16 was obtained in the same manner as in the preparation of the ink composition B1, except that titanium oxide 1 used in the ink composition B1 was changed to the titanium oxide 10, which is surface-untreated titanium oxide.

### Comparative Example B17

An ink composition B17 was obtained in the same manner as in the preparation of the ink composition B1, except that titanium oxide 1 used in the ink composition B1 was changed to the titanium oxide 11, which is surface-untreated titanium oxide.

<Evaluation>

As described below, a printed matter was prepared after preparing a diluted ink for each of the ink compositions obtained in the Test Example B, and laser marking was performed on the printed matter to evaluate the visibility of laser marking.

[Preparation of Diluted Inks B1 to 17]

Further, the resultant ink compositions B1 to 17 were each diluted with a dilution solvent containing methyl ethyl ketone/ethyl acetate/isopropyl alcohol in a volume ratio of 5/3/2 to adjust the viscosity to 18 sec at 25° C. in terms of Zahn cup No. 3 (manufactured by RIGO CO., LTD.), and thus diluted inks B1 to 17 were obtained.

[Preparation of Printed Matters B1 to 17]

Printed matters B1 to 17 were prepared from the resultant diluted inks B1 to 17, respectively. Specifically, gravure printing was performed on a polyester (PET)-based shrink film (trade name “SPACECLEAN S7042”, manufactured by Toyobo Co., Ltd.) having a thickness of 45 μm as a base material film with each diluted ink using a gravure plate having a plate depth of 40 μm. In this way, printed matters (shrink film printed matters) each having an ink layer (solid printed layer of 100 mm×150 mm, thickness of 3 μm) formed on the base material film with each diluted ink were obtained.

[Performing Laser Marking]

Laser marking was performed on each of the resultant laminate printed matters B1 to 17 to obtain recorded matters (shrink packaging labels) B1 to 17. Specifically, the region where the ink layer was provided was irradiated with laser light having a wavelength of 1060 to 1070 nm from the ink layer side using a YVO₄/fiber hybrid laser marker (trade name “MD-X1000”, manufactured by KEYENCE CORPORATION) to obtain recorded matters. “2017.09.01” (height of characters: 5 mm) in lightface was used as an irradiation pattern by the laser marker. With respect to the condition for irradiation with the laser marker, the scan speed was set to 1000 mm/sec; the pulse frequency was set to 20 kHz; and the average output for the irradiation pattern was set to 2.6 W. The visibility (sharpness) of the recorded characters (numerals) was evaluated for the resultant recorded matters B1 to 17 according to the evaluation criteria described in Example A.

Table 2-1 and Table 2-2 show: the amounts of the solid components used, the previously described ratios of the content of particular titanium oxide (B) to the content of the binder resin (A), (B_{I}/A, b₃/A, and (b₃+b₄)/A), the ratio of the content of ATO-treated titanium oxide (b₃) to the content of titanium oxide (b4), (b₃/b₄), in the ink compositions prepared in respective Examples in Test Example B; evaluation results of the visibility; and the like.

TABLE 2-1

| | | Example | | | | | | |
|---|---|---|---|---|---|---|---|---|
| | | B1 | B2 | B3 | B4 | B5 | B6 | B7 |
| Ink, printed matter,and recorded matter number | | B1 | B2 | B3 | B4 | B5 | B6 | B7 |
| Amount of solid | Polyurethane resin | 7.5 | 7.5 | 7.5 | 7.5 | 7.5 | 7.5 | 7.5 |
| content used in ink | Nitrocellulose resin | 2.5 | 2.5 | 2.5 | 2.5 | 2.5 | 2.5 | 2.5 |
| (parts) | Titanium oxide 1 | 50.0 | 40.0 | 60.0 | | | | |
| | Titanium oxide 2 | | | | 50.0 | | | |
| | Titanium oxide 5 | | | | | 50.0 | | |
| | Titanium oxide 6 | | | | | | 50.0 | |
| | Titanium oxide 9 | | | | | | | 50.0 |
| | Titanium oxide 10 | | | | | | | |
| | Titanium oxide 11 | | | | | | | |

| | | | | | | | |
|---|---|---|---|---|---|---|---|
| B_{I}/A | 5.0 | 4.0 | 6.0 | 5.0 | 5.0 | 5.0 | 5.0 |
| b₃/A | — | — | — | — | — | — | 5.0 |
| (b₃ + b₄)/A | — | — | — | — | — | — | — |
| b₃/b₄ | — | — | — | — | — | — | — |
| Visibility | A | B | A | A | B | A | AA |

TABLE 2-2

| | | Example | | | | | | | Comparative Example | | |
|---|---|---|---|---|---|---|---|---|---|---|---|
| | | B8 | B9 | B10 | B11 | B12 | B13 | B14 | B15 | B16 | B17 |
| Ink, printed matter, and recorded matter | | B8 | B9 | B10 | B11 | B12 | B13 | B14 | B15 | B16 | B17 |
| number | | | | | | | | | | | |
| Amount of solid | Polyurethane resin | 7.5 | 7.5 | 7.5 | 7.5 | 7.5 | 7.5 | 7.5 | 7.5 | 7.5 | 7.5 |
| content used in ink | Nitrocellulose resin | 2.5 | 2.5 | 2.5 | 2.5 | 2.5 | 2.5 | 2.5 | 2.5 | 2.5 | 2.5 |
| (parts) | Titanium oxide 1 | 50.0 | 50.0 | 50.0 | 50.0 | 40.0 | 30.0 | 20.0 | 20.0 | | |
| | Titanium oxide 2 | | | | | | | | | | |
| | Titanium oxide 5 | | | | | | | | | | |
| | Titanium oxide 6 | | | | | | | | | | |
| | Titanium oxide 9 | 2.5 | 1.0 | 0.5 | 0.2 | 0.5 | 0.5 | 0.5 | | | |
| | Titanium oxide 10 | | | | | | | | | 50.0 | |
| | Titanium oxide 11 | | | | | | | | | | 50.0 |

| | | | | | | | | | | |
|---|---|---|---|---|---|---|---|---|---|---|
| B_{I}/A | 5.3 | 5.1 | 5.1 | 5.0 | 4.1 | 3.1 | 2.1 | 2.0 | — | — |
| b₃/A | 0.25 | 0.10 | 0.05 | 0.02 | 0.05 | 0.05 | 0.05 | — | — | — |
| (b₃ + b₄)/A | 5.25 | 5.10 | 5.05 | 5.02 | 4.05 | 3.05 | 2.05 | — | — | — |
| b₃/b₄ | 0.050 | 0.020 | 0.010 | 0.004 | 0.013 | 0.017 | 0.025 | — | — | — |
| Visibility | AA | AA | AA | A | AA | A | B | D | D | D |

### Test Example C

In Test Example C, ink compositions were prepared under the supposition that the ink compositions were applied to a tray for food, each of the prepared ink compositions was printed on a plastic film for a tray as a base material, and laser marking was performed on resultant printed matters to evaluate the visibility.

[Preparation of Binder Resins]

As binder resins to be contained in the ink compositions, an acrylic resin solution (trade name “1LO-449”, manufactured by Taisei Fine Chemical Co., Ltd., contained solvent: ethyl acetate and isopropyl alcohol) having a solid content of 40%, and a cellulose acetate butyrate (CAB) resin solution having a content of 20% were used. As the CAB resin solution, a CAB resin solution obtained by dissolving 20.0 parts of a CAB resin (trade name “CAB381-0.5”, manufactured by Eastman Chemical Company Japan) in 80.0 parts of a solvent obtained by mixing isopropyl alcohol and ethyl acetate in equal amounts on a volume basis was used.

### Preparation of Ink Compositions

### Example C1

An ink composition C1 was obtained by mixing 40.0 parts of the titanium oxide 1, which is alumina-silica composite-treated titanium oxide, 9.0 parts of the acrylic resin solution in terms of the solid content (22.5 parts as solution), 1.0 part of the CAB resin solution in terms of the solid content (5.0 parts as solution), and 32.5 parts of a mixed solvent containing ethyl acetate/isopropyl alcohol in a volume ratio of 4/6, and milling the mixture with a paint shaker.

### Example C2

An ink composition C2 was obtained by mixing 30.0 parts of the titanium oxide 1, 1.0 part of the titanium oxide 9, which is ATO-treated titanium oxide, 9.0 parts of the acrylic resin solution in terms of the solid content (22.5 parts as solution), 1.0 part of the CAB resin solution in terms of the solid content (5.0 parts as solution), and 41.5 parts of a mixed solvent containing ethyl acetate/isopropyl alcohol in a volume ratio of 4/6, and milling the mixture with a paint shaker.

### Example C3

An ink composition C3 was obtained in the same manner as in the preparation of the ink composition C2, except that the amounts of titanium oxide 9 and the mixed solvent used in the ink composition C2 (1.0 part and 41.5 parts, respectively) were changed to 2.0 parts and 40.5 parts, respectively.

### Example C4

An ink composition C4 was obtained in the same manner as in the preparation of the ink composition C2, except that the amounts of titanium oxide 9 and the mixed solvent used in the ink composition C2 (1.0 part and 41.5 parts, respectively) were changed to 3.0 parts and 39.5 parts, respectively.

### Example C5

An ink composition C5 was obtained in the same manner as in the preparation of the ink composition C2, except that the amounts of titanium oxide 9 and the mixed solvent used in the ink composition C2 (1.0 part and 41.5 parts, respectively) were changed to 5.0 parts and 37.5 parts, respectively.

### Comparative Example C6

An ink composition C6 was obtained in the same manner as in the preparation of the ink composition C1, except that the amounts of titanium oxide 1 and the mixed solvent used in the ink composition C1 (40.0 parts and 32.5 parts, respectively) were changed to 10.0 parts and 62.5 parts, respectively.

### Comparative Example C7

An ink composition C7 was obtained in the same manner as in the preparation of the ink composition C1, except that the amounts of titanium oxide 1 and the mixed solvent used in the ink composition C1 (40.0 parts and 32.5 parts, respectively) were changed to 20.0 parts and 52.5 parts, respectively.

<Evaluation>

As described below, a printed matter was prepared after preparing a diluted ink for each of the ink compositions obtained in the Test Example C, and laser marking was performed on the printed matter to evaluate the visibility of laser marking.

[Preparation of Diluted Inks C1 to 7]

Further, the resultant ink compositions C1 to 7 were each diluted with a dilution solvent containing ethyl acetate/isopropyl alcohol in a volume ratio of 4/6 to adjust the viscosity to 18 sec at 25° C. in terms of Zahn cup No. 3 (manufactured by RIGO CO., LTD.), and thus diluted inks C1 to 7 were obtained.

[Preparation of Printed Matters C1 to 7]

Printed matters C1 to 7 were prepared from the resultant diluted inks C1 to 7, respectively. Specifically, gravure printing was performed on an amorphous polyethylene terephthalate (A-PET) film (trade name “P 0.30×640”, manufactured by MINERON KASEI CO., LTD.) having a thickness of 300 μm as a base material film with each diluted ink using a gravure plate having a plate depth of 40 μm. In this way, printed matters each having an ink layer (solid printed layer of 100 mm×150 mm, thickness of 3 μm) formed on the base material film with each diluted ink were obtained.

[Performing Laser Marking]

Laser marking was performed on each of the resultant printed matters C1 to 7 to obtain recorded matters (films for tray) C1 to 7. Specifically, the region where the ink layer was provided was irradiated with laser light having a wavelength of 1060 to 1070 nm from the ink layer side using a YVO₄/fiber hybrid laser marker (trade name “MD-X1000”, manufactured by KEYENCE CORPORATION) to obtain recorded matters. “2017.09.01” (height of characters: 5 mm) in lightface was used as an irradiation pattern by the laser marker. With respect to the condition for irradiation with the laser marker, the scan speed was set to 1000 mm/sec; the pulse frequency was set to 20 kHz; and the average output for the irradiation pattern was set to 2.6 W. The visibility (sharpness) of the recorded characters (numerals) was evaluated for the resultant recorded matters C1 to 7 according to the evaluation criteria described in Example A.

Table 3 shows: the amounts of the solid components used, the previously described ratios of the content of particular titanium oxide (B) to the content of the binder resin (A), (B_{I}/A, b₃/A, and (b₃+b₄)/A), the ratio of the content of ATO-treated titanium oxide (b₃) to the content of titanium oxide (b₄), (b₃/b₄), each in the ink compositions prepared in respective Examples in Test Example C; and evaluation results of the visibility; and the like.

TABLE 3

| | | Example | | | | | Comparative Example | |
|---|---|---|---|---|---|---|---|---|
| | | C1 | C2 | C3 | C4 | C5 | C6 | C7 |
| Ink, printed matter, and recorded matter | | C1 | C2 | C3 | C4 | C5 | C6 | C7 |
| number | | | | | | | | |
| Amount of solid | Acrylic resin | 9.0 | 9.0 | 9.0 | 9.0 | 9.0 | 9.0 | 9.0 |
| content used in ink | CAB resin | 1.0 | 1.0 | 1.0 | 1.0 | 1.0 | 1.0 | 1.0 |
| (parts) | Titanium oxide 1 | 40.0 | 30.0 | 30.0 | 30.0 | 30.0 | 10.0 | 20.0 |
| | Titanium oxide 9 | | 1.0 | 2.0 | 3.0 | 5.0 | | |

| | | | | | | | |
|---|---|---|---|---|---|---|---|
| B_{I}/A | 4.0 | 3.0 | 3.0 | 3.0 | 3.0 | 1.0 | 2.0 |
| b₃/A | — | 0.10 | 0.20 | 0.30 | 0.50 | — | — |
| (b₃ + b₄/A | — | 3.10 | 3.20 | 3.30 | 3.50 | — | — |
| b₃/b₄ | — | 0.033 | 0.067 | 0.100 | 0.167 | — | — |
| Visibility | B | B | A | A | AA | D | C |

1. A laser marking ink composition to be used for forming a laser marking layer, the ink composition comprising:
a binder resin (A); and
titanium oxide (B) that causes color development in the laser marking layer by irradiation with laser light, wherein
the titanium oxide (B) comprises at least one surface-treated titanium oxide (B_{I}) selected from the group consisting of titanium oxide (b₁) surface-treated with alumina, titanium oxide (b₂) surface-treated with alumina and silica, and titanium oxide (b₃) coating-treated with antimony-doped tin oxide, and
at least one of the following conditions 1 and 2 is satisfied:
condition 1: a ratio of a content of the surface-treated titanium oxide (B_{I}) to a content of the binder resin (A), (B_{I}/A), is 2.5 to 6.5 on a solid content mass ratio basis; and
condition 2: the titanium oxide (B) comprises at least the titanium oxide (b₃), and a ratio of a content of the titanium oxide (b₃) to a content of the binder resin (A), (b₃/A), is 1.0 to 6.5 on a solid content mass ratio basis.

2. The laser marking ink composition according to claim 1, wherein the titanium oxide (b₁) surface-treated with alumina and the titanium oxide (b₂) surface-treated with alumina and silica each have an oil absorption of 15 to 55 g/100 g.

3. A laser marking ink composition to be used for forming a laser marking layer, the ink composition comprising:
a binder resin (A); and
titanium oxide (B) that causes color development in the laser marking layer by irradiation with laser light, wherein
the titanium oxide (B) comprises:
titanium oxide (b₃) coating-treated with antimony-doped tin oxide; and
titanium oxide (b₄) other than the titanium oxide (b₃), the titanium oxide (b₄) having an oil absorption of 19 g/100 g or more, and
a ratio of a total content of the titanium oxide (b₃) and the titanium oxide (b₄) to a content of the binder resin (A), [(b₃+b₄)/A], is 1.0 to 6.5 on a solid content mass ratio basis.

4. The laser marking ink composition according to claim 3, wherein the titanium oxide (b₄) having an oil absorption of 19 g/100 g or more comprises any one or both of titanium oxide (b₁) surface-treated with alumina and titanium oxide (b₂) surface-treated with alumina and silica.

5. The laser marking ink composition according to claim 1, wherein the binder resin (A) comprises any one or both of a polyurethane resin and an acrylic resin.

6. A packaging material comprising:
a base material; and
a laser marking layer provided on the base material, wherein the laser marking layer is formed with the laser-marking ink composition according to claim 1.
